(19) United States
(12) Patent Application Publication
(10) Pub. No.: US 2011/0278026 A1
(43) Pub. Date: Nov. 17, 2011

(54) Sprinkler System With Rapid Installation

(76) Inventor: Chaim Sterm, Monroe, NY (US)

(21) Appl. No.: 12/778,243

(22) Filed: May 12, 2010

(51) Int. Cl. A62C 37/08

(52) U.S. Cl. 169/41; 169/37

(57) ABSTRACT

A fire protection system includes fire sprinklers having a male member of a quick-connect coupling. Corresponding female members of a quick-connect coupling are molded into plastic water pipe couplings forming a water supply and distribution system or, alternatively, threaded into metal pipe couplings.

### FIELD OF THE INVENTION

The present invention relates generally to the field of fire safety equipment and more particularly to a sprinkler system with rapid installation capability.

### BACKGROUND OF THE INVENTION

New construction of commercial structures typically requires the installation of automatic sprinkler systems. In addition to commercial structures, numerous types of residential buildings also require installation of sprinkler systems either as new construction or as retrofit construction. In order to provide the most effective fire protection, these systems utilize a relatively large number of heat activated sprinkler heads.

Conventional sprinkler heads include a pipe thread type fitting which must be individually manually threaded into various water supply pipes. The sprinkler heads must be tightened carefully to avoid leaks. In many cases, teflon tape is applied to the joint prior to assembly in an effort to prevent leakage.

The installation of sprinkler heads typically requires overhead work using relatively heavy wrenches and the relatively large number of sprinkler heads in a typical installation results in a time consuming and costly effort.

### OBJECTS AND SUMMARY OF THE INVENTION

It is an object of the present invention to provide a sprinkler system which can be installed rapidly.

Another object of the present invention is to provide a sprinkler system in which the sprinkler heads can be installed without a need for tools of any kind.

Another object of the present invention is to provide a sprinkler system which can be used with both metal and chlorinated poly vinyl chloride (CPVC) water supply pipes.

Yet another object of the present invention is to provide a sprinkler system which has components which can be manufactured economically resulting in a relatively low system cost.

In accordance with the present invention, there is provided a sprinkler system for rapid installation in a water supply system for fire protection which includes a plurality of water supply pipes. The sprinkler system includes automatic sprinkler heads which include quick-connect couplings. The sprinkler heads release a spray of water from the water supply pipes when the area being protected reaches a temperature in excess of a preset limit. The sprinkler heads are connected to the water supply pipes by the quick-connect couplings. Each of the quick-connect couplings has a male member and a female member with the female member forming part of a tee or elbow coupling.

In installations which utilize CPVC pipe, the female member of the coupling is molded into the CPVC pipe during the manufacture of the CPVC pipe. In installations which utilize metal pipes, the female member of the coupling is threaded into a standard pipe thread portion during the fabrication of the metal pipe segments.

The quick-connect couplings facilitate the rapid installation of the automatic sprinkler heads and eliminate the need for difficult, time consuming and burdensome on-site installation which is required by conventional fire protection sprinkler systems.

These and other aspects of the invention will become apparent from the following description of the preferred embodiments taken in conjunction with the following drawings, although variations and modifications may be effected without departing from the spirit and scope of the novel concepts of the disclosure.

### BRIEF DESCRIPTION OF THE DRAWINGS

FIG. 1 is an elevation view of a sprinkler system with rapid installation according to the present invention showing a CPVC tee head assembly with a molded-in female portion of a quick connect coupling;

FIG. 2 is an exploded view of the CPVC tee head assembly of FIG. 1;

FIG. 3 is an end view taken along the line 3-3 of FIG. 2;

FIG. 4 is a cross-sectional view taken along the line 4-4 of FIG. 3 showing the molded-in female quick connect coupling;

FIG. 5 is a cross-sectional view of the female portion of the quick-connect coupling of FIG. 1;

FIG. 6 is an exploded view of the female portion of the quick connect coupling of FIG. 5;

FIG. 7 is a side elevation view of the female portion of the quick connect coupling of FIG. 5;

FIG. 8 is a cross-sectional view taken along the line 8-8 of FIG. 5;

FIG. 9 is a bottom view of the female quick connect coupling of FIG. 5 taken along the line 9-9 of FIG. 7;

FIG. 10 is a side elevation view of an alternate embodiment of the invention showing a CPVC elbow incorporating the molded-in female portion of the quick connect coupling of FIG. 1;

FIG. 11 is a side elevation view taken along the line 11-11 of FIG. 10;

FIG. 12 is a cross-sectional view taken along the line 12-12 of FIG. 11;

FIG. 13 is an alternative embodiment of the invention showing a metal tee head assembly with a threaded female quick connect coupling;

FIG. 14 is an exploded view of the embodiment of FIG. 13;

FIG. 15 is a cross-sectional view of the threaded female quick connect coupling of FIG. 13;

FIG. 16 is an exploded view of another alternative embodiment of the invention showing a metal elbow coupling with a threaded female quick connect coupling;

FIG. 17 is a vertical cross-sectional view of the CPVC tee head assembly of FIGS. 1 and 2 showing the assembled CPVC tee head assembly; and

FIG. 18 is a vertical cross-sectional view similar to FIG. 17 showing the collar pulled downward and the CPVC tee head assembly ready for installation or removal of the male member.

### DETAILED DESCRIPTION OF THE INVENTION

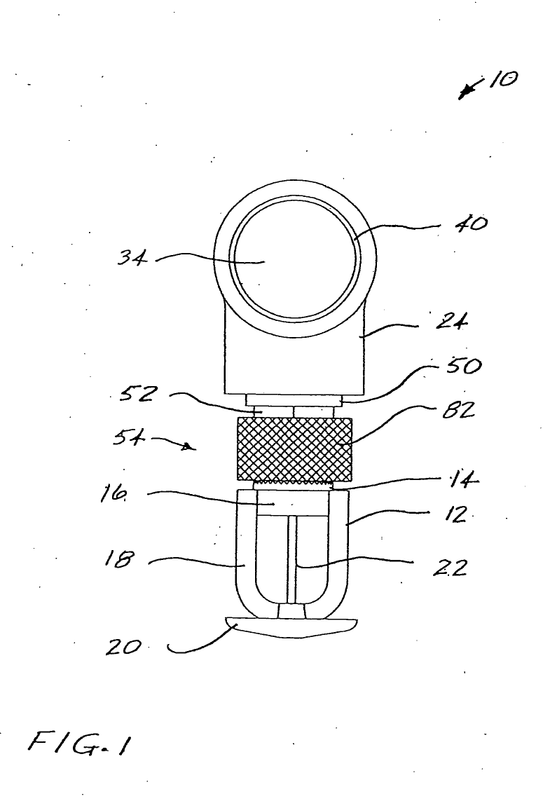

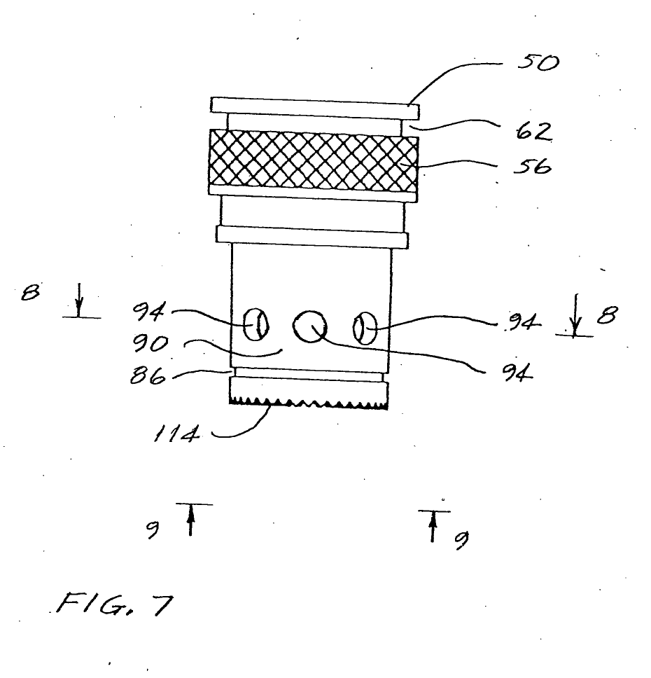

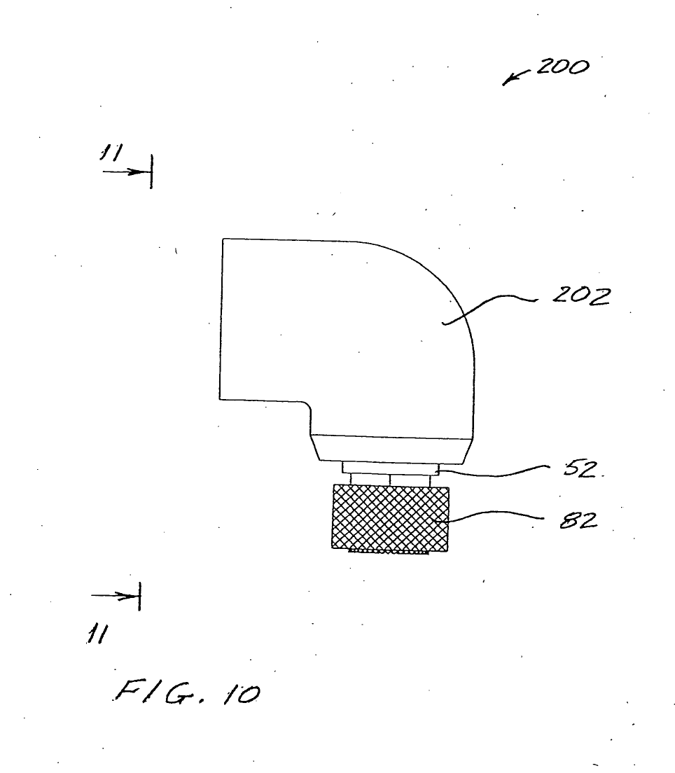

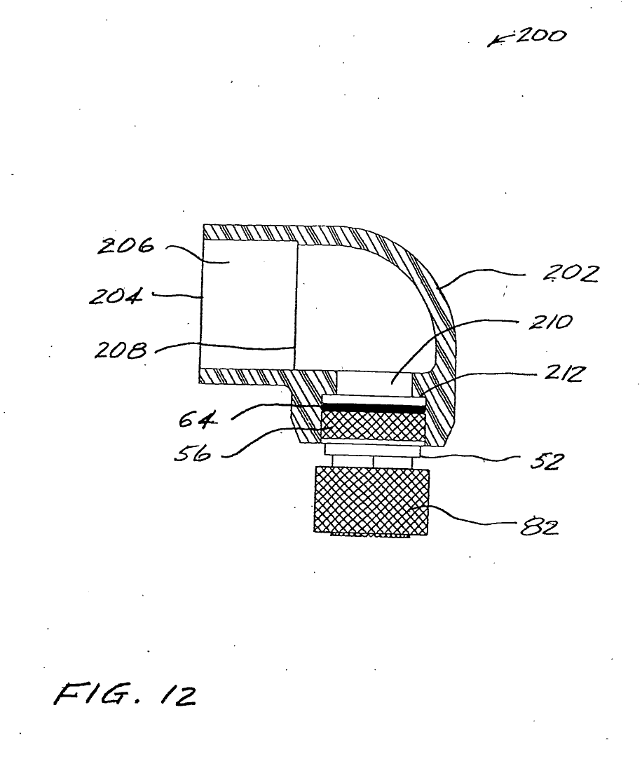

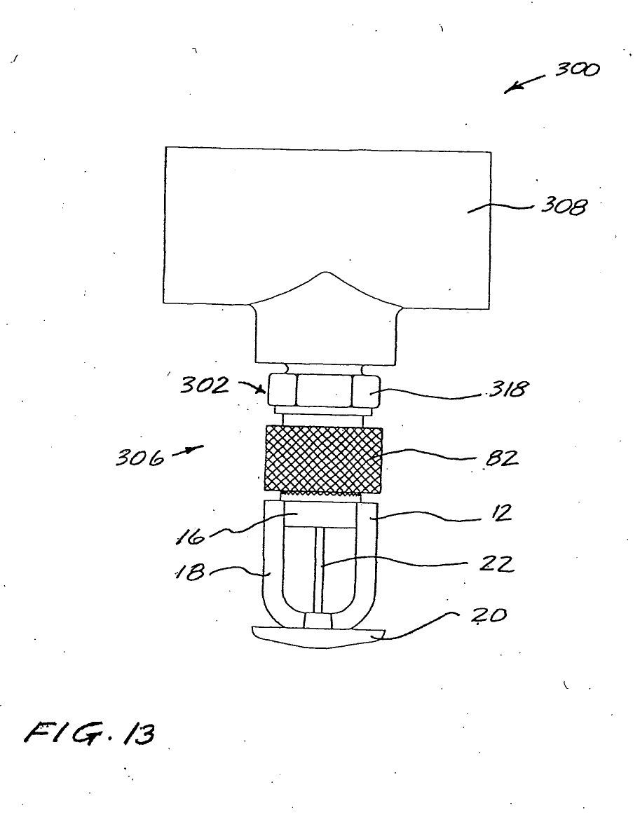

With reference to the drawings, there is shown in FIGS. 1-18 a sprinkler system 10 with rapid installation capability which includes a water supply system including a plurality of pipes and a plurality of fire sprinkler heads 12. The design and construction of water distribution pipes for water supply systems is well known in the art and therefore need not be further described. The fire sprinkler heads 12 discharge water when the area being protected reaches a predetermined temperature. The fire sprinkler heads 12 form a key feature of the present invention.

Fire sprinkler heads 12 in accordance with the present invention in general may incorporate a heat-sensitive glass bulb or a metal link which is held together by a thermally fusible alloy. The glass bulb or the metal link apply pressure to a plug in a valve body which prevents water from flowing until a predetermined ambient temperature has been reached. The details of construction of conventional fire sprinkler heads 12 are known in the art and therefore the details of the conventional portions of the fire sprinkler head 12 have not been described other than to indicate the major components including the body 50, valve 16, support frame 18, deflector 20 and frangible glass bulb 22.

When a pre-selected temperature has been reached, the frangible glass bulb 22 breaks and water flows through the valve 16 onto the deflector 20. The deflector 20 may be shaped to direct the water in a preselected pattern.

FIGS. 1-4 show a chlorinated polyvinyl chloride (CPVC) plastic tee fitting 24 which has a molded-in female member 52 which forms an important feature of the present invention. The tee fitting 24 is connected to a plurality of pipes illustrated typically as pipes 28 and 30 by conventional solvent welding techniques. It is clear that while CPVC has been described, alternative plastic materials which are known in the art may be used as part of the present invention.

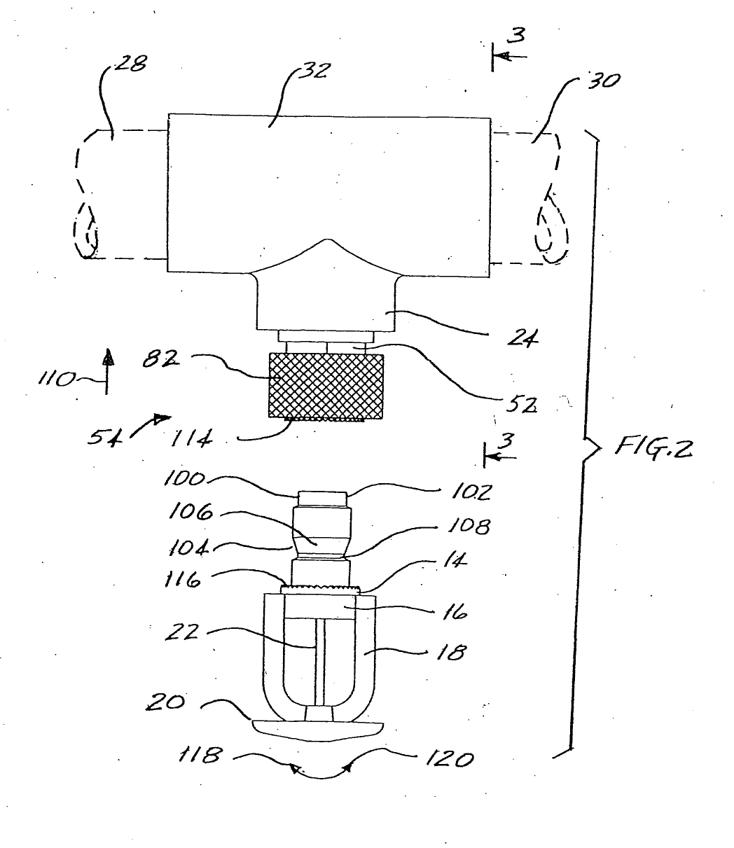

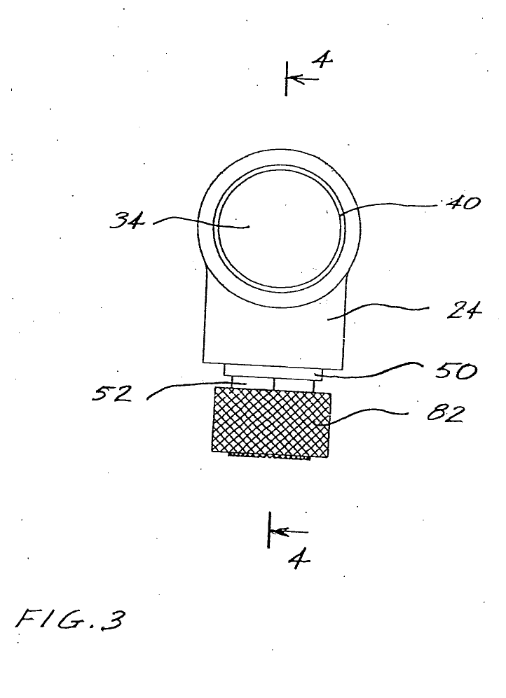

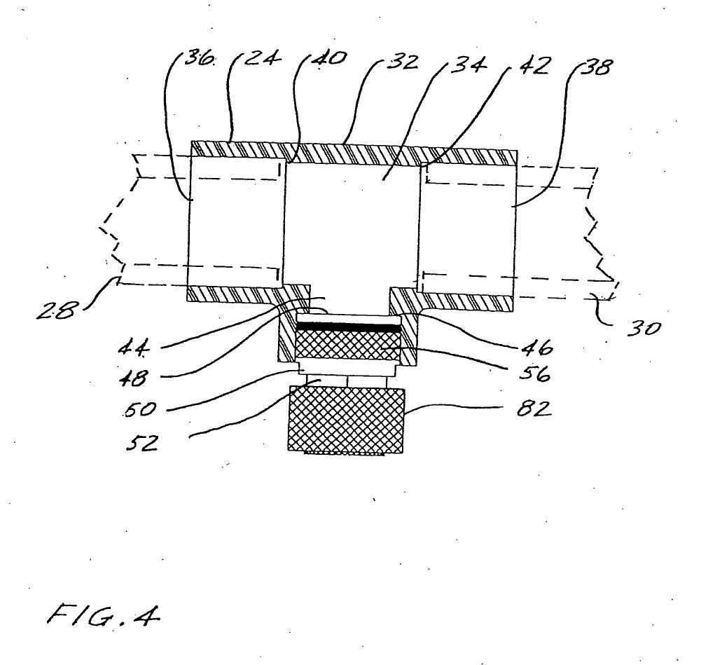

As is shown in FIG. 4, the CPVC tee 24 has a base portion 32 with a through bore 34 and a pair of openings 36 and 38. A pair of step portions 40 and 42 are formed in the bore 34. The step portions facilitate insertion and solvent welding of the base portion 32 to adjacent CPVC pipes 28 and 30 which are shown in broken lines in FIGS. 2 and 4. The adjacent CPVC pipes 28 and 30 and the solvent welding process are conventional and well known in the art and have not been further described.

As is best shown in FIG. 4, the through bore 34 intersects the discharge bore 44. The discharge bore 44 leads to a step portion 46 which receives the upper end 48 of the body 50 of the female member 52 of the molded-in quick-connect coupling 54.

The molded-in quick connect coupling 54 forms a key feature of the present invention and includes the molded-in female member 52 and a male member 100 which will be presently described.

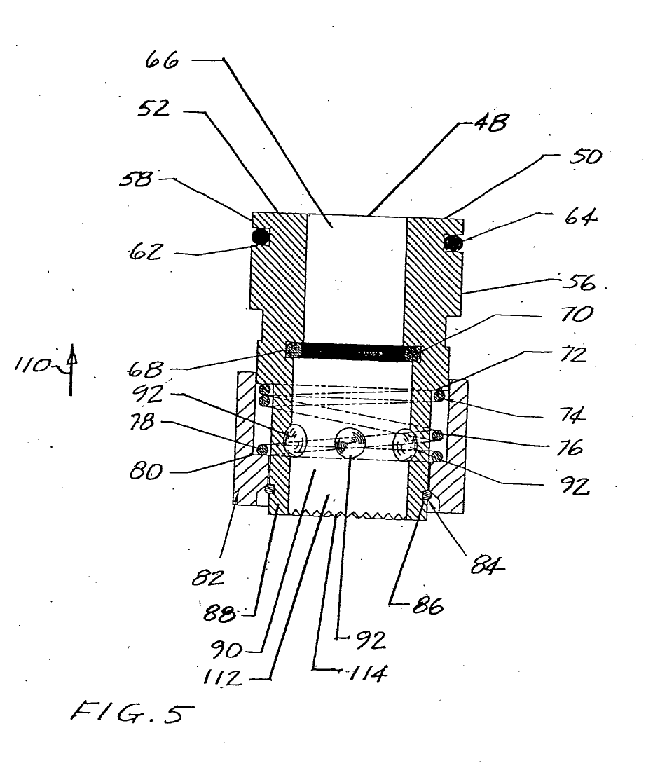

As is best shown in FIG. 5, the body 50 of the molded-in female member 52 includes a surface 56 which has a deep knurl. The upper end 58 of the body 50 has a groove 62 in which an outer O-ring 64 is seated.

As is shown in FIG. 4, the knurled surface 56 and the outer O-ring 64 are molded into the CPVC tee 24 during the manufacture of the CPVC tee 24. The combination of the outer O-ring 64 and the knurled surface 56 ensures sealing contact between the body 50 and the CPVC tee 24 and prevents leakage.

As is shown in FIG. 5, the body 50 of the female member 52 of the quick-connect coupling 54 includes a through bore 66 which has a groove 68 which houses an inner O-ring 70. The body 50 includes a shoulder 72 against which the first end 74 of a helical compression spring 76 bears. The second end 78 of the spring 76 bears against a shoulder 80 formed on a collar 82 which is slideable mounted on the body 50.

The collar 82 is retained on the body 50 by a retaining ring 84 which is mounted in a groove 86 formed in the end portion 88 of the body 50.

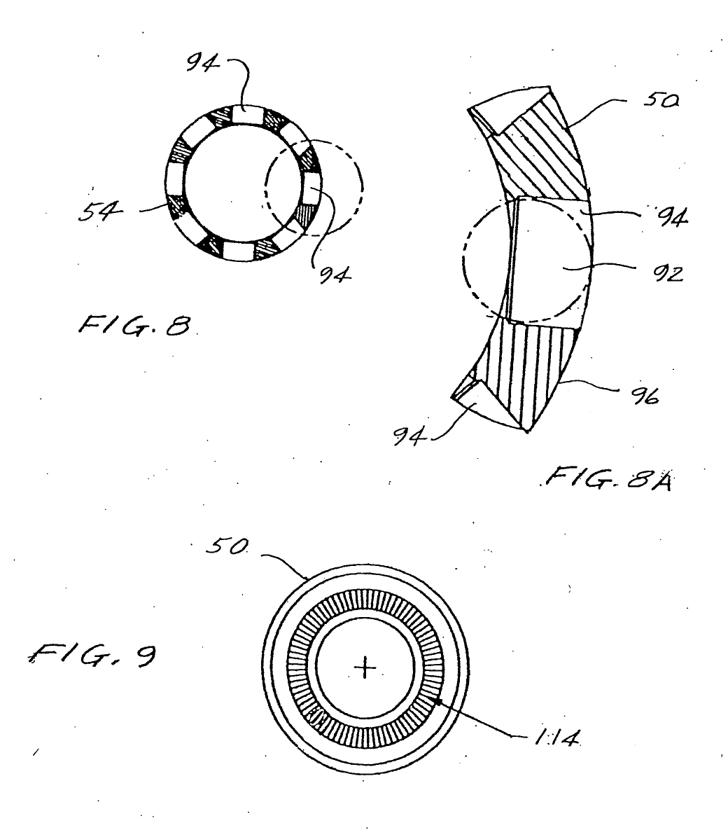

An intermediate portion 90 of the body 50 has a plurality of locking balls 92 which are retained in counterbored holes 94 as shown in FIGS. 8 and 8A. In FIG. 8A, the locking ball 92 is depicted in broken lines. The locking balls 92 and the counterbored holes are proportioned so that when in the position shown in FIG. 8A, the balls 92 are flush or slightly below the surface 96 of the body 50.

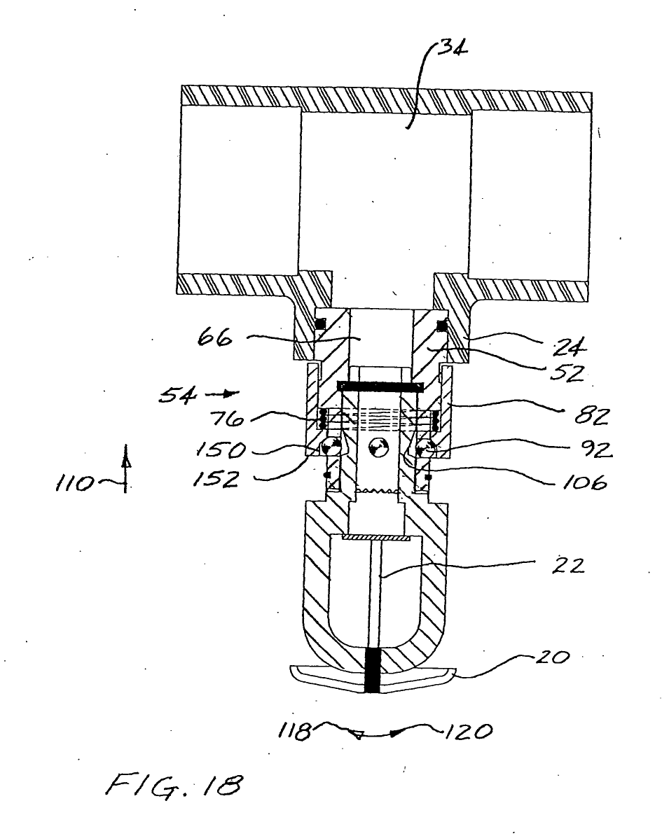

As is best shown in FIGS. 2 and 17, the male member 100 of the quick connect coupling 54 includes a body 102 having a central through bore 148 which leads to the valve portion 16. The body 102 is generally cylindrical having a groove portion 104 which includes an inwardly sloping frusto-conical portion 106 and a cylindrical portion 108 disposed at the smaller diameter of the frusta-conical portion 106.

When the male member 100 of the quick-connect coupling 54 is inserted into the bore 66 of the female member 52, the locking balls 92 lodge in the groove portion 106. When the collar 82 is moved in the direction shown by the arrow 110 compressing the spring 76, the locking balls 92 leave the groove portion 106 and the male portion 100 and can be easily withdrawn from or inserted into the female member 52.

The lower portion 112 of the body 50 has a circular array of teeth 114 which mesh with a complementary array of teeth 116 formed on the male member 100. When the male member 100 is fully inserted into the female member 52, the two teeth arrays 114 and 116 are in mesh. The teeth arrays 114 and 116 facilitate the adjustment of the rotational position of the male member 100 to the female member 52 as indicated by the arrows 118 and 120 in FIG. 2. This feature facilitates the positioning of the deflector 20 to direct the flow of water in a desired pattern.

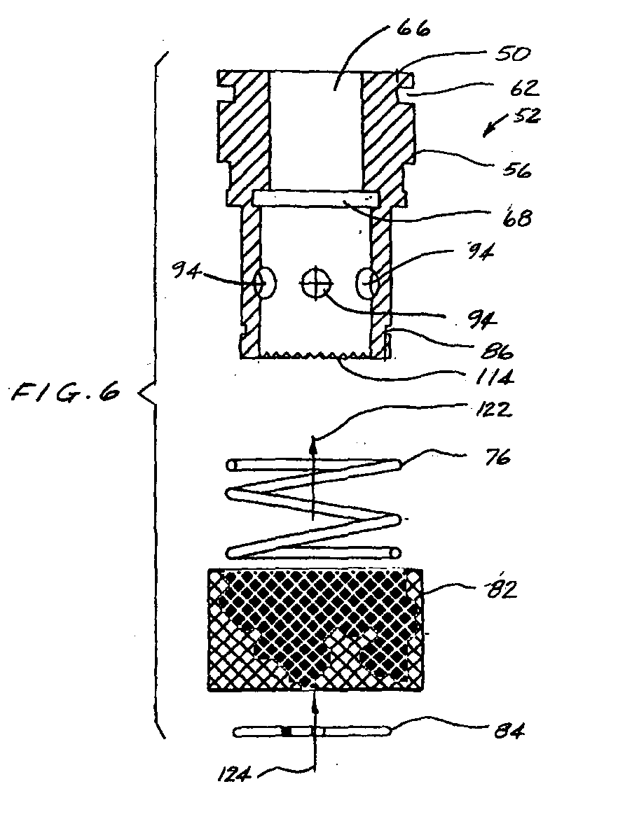

FIG. 6 shows an exploded view of the female member 52 of the quick-release coupling 54. The outer O-ring 64, the inner O-ring 70 and the locking balls 92 have been removed for clarity of illustration. The female member 52 is assembled by moving the spring 76 and the collar 82 in the directions shown by the arrows 122 and 124 in FIG. 6. The collar 82 is retained on the body 50 by the retaining ring 84.

FIGS. 17 and 18 show the assembly and disassembly of the quick connect coupling 54. The valve body 16 shown in FIG. 2 has been removed for clarity of illustration.

When the collar 82 is pulled in an upward direction, shown by the arrow 110, compressing the spring 76, the locking balls 92 lodge in the recess 150 formed in the lower end 152 of the collar 82. When the locking balls 92 lodge in the recess 150, the male member 100 of the quick connect coupling 54 can be easily inserted into the bore 66 of the female member 52 or withdrawn from the bore 66.

When the collar 82 is released, the spring 76 moves the collar 82 to the position shown in FIG. 17 and the locking balls 92 lodge in the groove portion 106. When the locking balls lodge in the groove portion 106, the male member 100 and the female member 52 lock together as shown in FIG. 17. When the collar 82 is again moved in the direction of the arrow 110, overcoming the spring 76, the locking balls 92 leave the groove portion 106 and the male member 100 can be withdrawn from the female member 52 by adjusting the relative rotational position of the male 100 and female 52 members as indicated by the arrows 118 and 120.

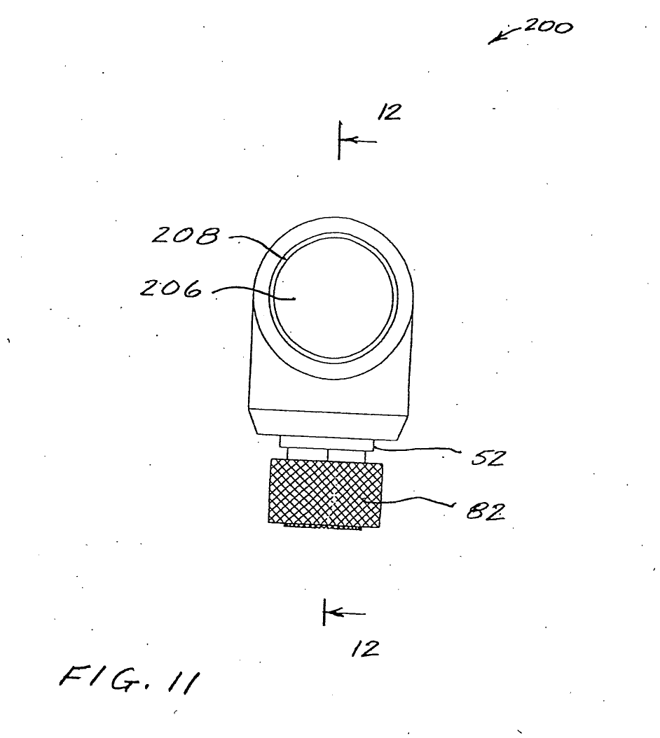

FIGS. 10-12 show an alternative embodiment of the invention 200 in which the female member 52 of a quick-release coupling 54 previously described is molded into a CPVC plastic elbow coupling 202. The details of construction of the female member 52 of the quick-release coupling 54 are identical to the unit previously described in connection with FIGS. 1-9. The elbow coupling 202 includes an aperture 204 which leads to a bore 206 which includes a step portion 208. The bore 206 leads to a perpendicular bore 210 which includes a step portion 212. The upper end of the female member 52 bears against the step portion 212 and the female member 52 includes an outer O-ring 64 and a knurled surface 56 as previously described. The female member 52 of the quick-release coupling 54 is molded into the CPVC plastic elbow 202 in the manner previously described in connection with the tee coupling in FIGS. 1-9. The female portion includes a collar 82 which has also been previously described.

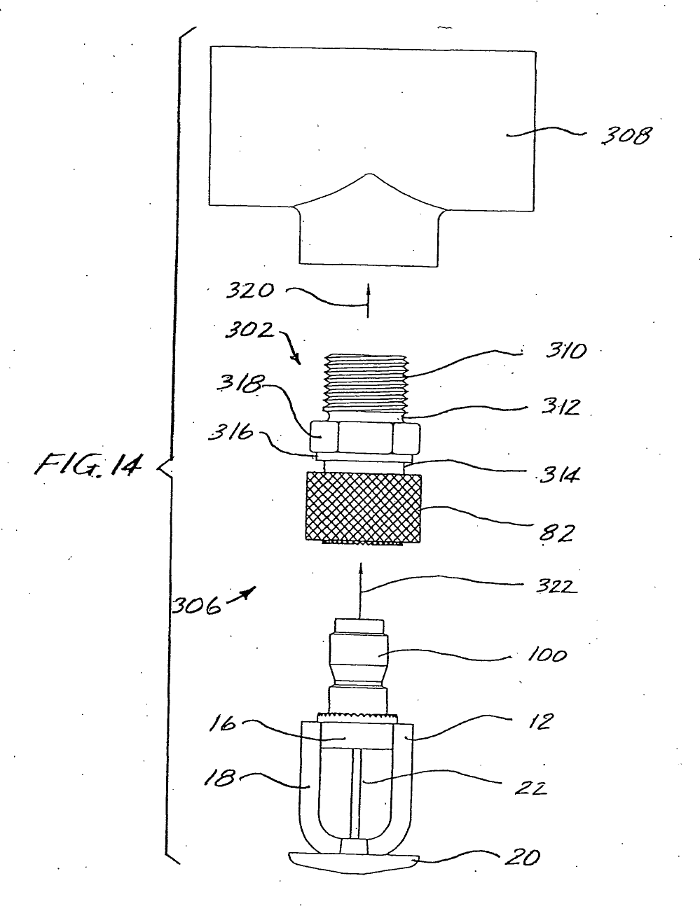

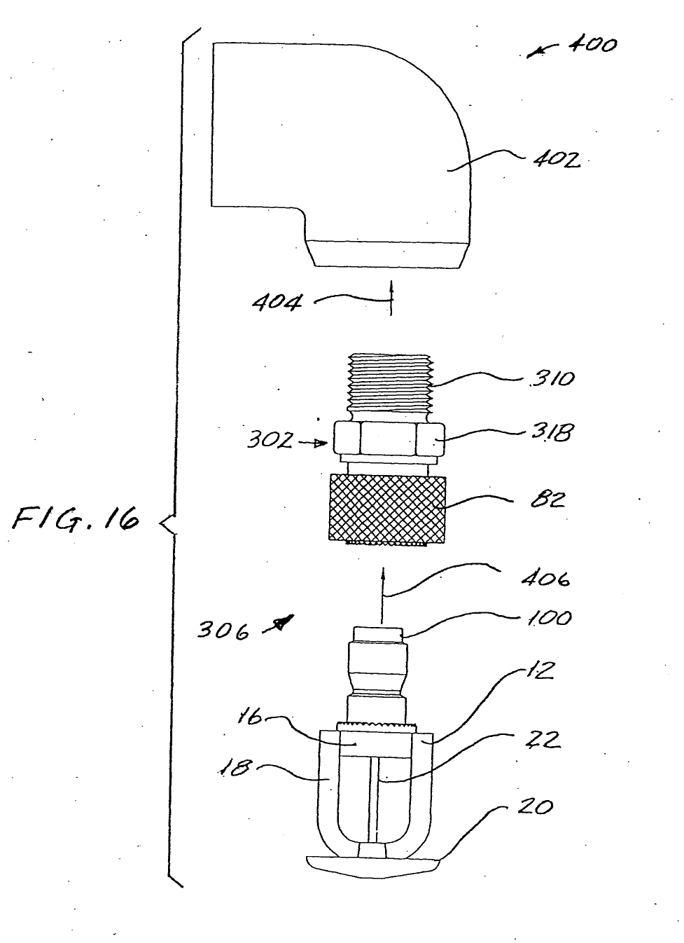

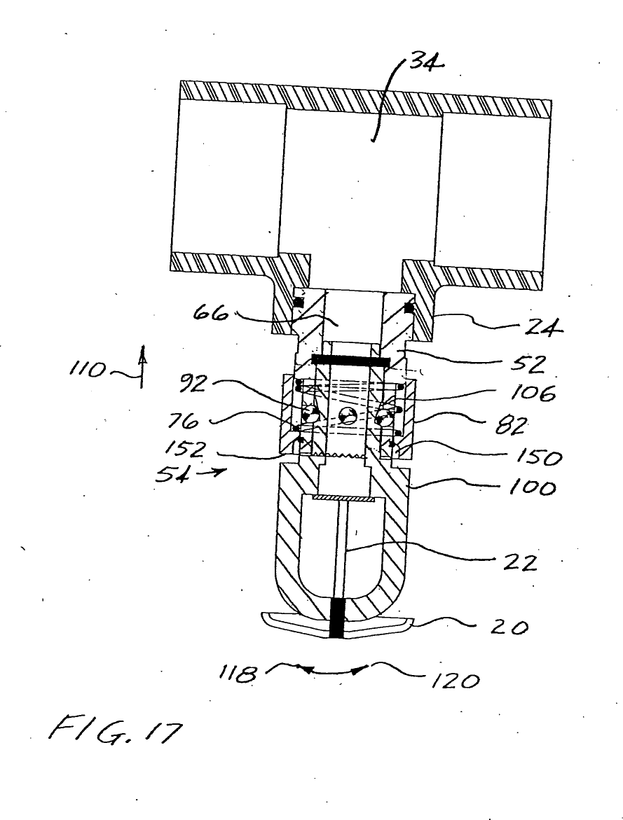

FIGS. 13-16 show alternative embodiments of the invention 300 and 400 in which the female member 302 of the quick-release coupling 306 is connected to a metal tee 308 in FIGS. 13-15 and to a metal elbow 402 in FIG. 16.

As shown in FIGS. 13-16, the female member 302 of the quick-release coupling 54, previously described, has been modified to include a pipe thread portion 310 at the end 312 of the body 314. An intermediate portion 316 of the female member 302 includes a hex portion 318.

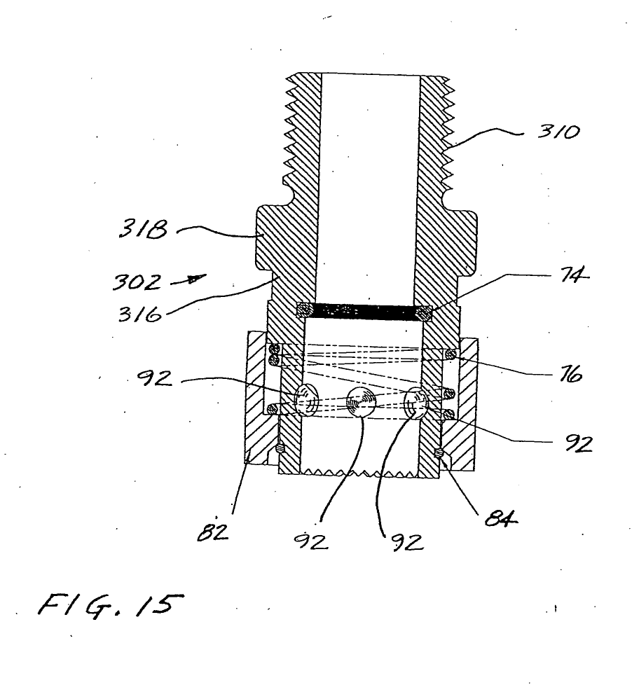

The pipe thread portion 310 enables the female member 302 of the quick-release coupling 306 to be threaded into the tee coupling 308 in the direction shown by the arrow 320 in FIG. 14. The male member 100 of the fire sprinkler head 12 is inserted into the female member 302 quick-release coupling 306 in the direction shown by the arrow 322 in FIG. 14. The remaining details of construction of the female member 302, the male portion 100 and the fire sprinkler head 12 are identical to the corresponding components previously described in connection with FIGS. 1-12 and FIGS. 17-18.

FIG. 16 shows the quick-release coupling 306 being assembled by threading the female member 302 into the metal elbow 402 in the direction shown by the arrow 404. The male member 100 is inserted into the female member 302 as previously described.

The embodiments 300 and 400 enable the female member 302 of the quick-release coupling 306 to be assembled in the factory, thus eliminating the need for difficult and costly on-site overhead labor effort.

The foregoing specific embodiments of the present invention as set forth in the specification herein are for illustrative purposes only. Various deviations and modifications may be made within the spirit and scope of this invention without departing from a main theme thereof.

What is claimed is:

1. A sprinkler system with rapid installation comprising:
a pipe coupling;
a quick-connect coupling connected to said pipe coupling; and
a fire sprinkler head connected to said quick release coupling.

2. The sprinkler system as claimed in claim 1 wherein said pipe coupling comprises:
a tee coupling.

3. The sprinkler system as claimed in claim 1 wherein said pipe coupling comprises:
an elbow coupling.

4. The sprinkler system as claimed in claim 1 wherein said pipe coupling comprises:
a plastic pipe coupling.

5. The sprinkler system as claimed in claim 1 wherein said pipe coupling comprises:
a metal pipe coupling.

6. The sprinkler system as claimed in claim 1 wherein said pipe coupling comprises:
a chlorinated polyvinyl chloride pipe coupling.

7. The sprinkler system as claimed in claim 1 wherein said fire sprinkler head comprises:
a heat sensitive glass bulb fire sprinkler.

8. The sprinkler system as claimed in claim 1 wherein said fire sprinkler head comprises:
a thermally fusible link fire sprinkler.

9. The sprinkler system as claimed in claim 1 wherein:
said quick-connect coupling comprises:
a male member, and
a female member.

10. The sprinkler system as claimed in claim 1 wherein:
said female member is connected to said pipe coupling.

11. The sprinkler system as claimed in claim 4 wherein said quick-connect coupling is molded into said plastic pipe coupling.

12. The sprinkler system as claimed in claim 5 wherein said quick-connect coupling is threaded into said metal coupling.

13. The sprinkler system as claimed in claim 1 wherein said quick-connect coupling comprises:
a plurality of locking balls.

14. The sprinkler system as claimed in claim 1 wherein said quick-connect coupling comprises:
at least one O-ring.

15. The sprinkler system as claimed in claim 1 wherein said quick-connect coupling comprises:
a spring loaded collar.

16. The sprinkler system as claimed in claim 1 wherein said quick-connect coupling comprises:
a male member, and
a female member and wherein said fire sprinkler head is connected to said male member.
